(19) United States
(12) Patent Application Publication
(10) Pub. No.: US 2020/0199955 A1
(43) Pub. Date: Jun. 25, 2020

(54) CONTAINMENT AND DELIVERY SYSTEM FOR HARSH FLUIDS

(71) Applicant: HALLIBURTON ENERGY SERVICES, INC., Houston, TX (US)

(72) Inventors: Jim Basuki SURJAATMADJA, Duncan, OK (US); Timothy Holiman HUNTER, Duncan, OK (US); Stanley Vernon STEPHENSON, Duncan, OK (US)

(73) Assignee: HALLIBURTON ENERGY SERVICES, INC., Houston, TX (US)

(21) Appl. No.: 16/635,380

(22) PCT Filed: Sep. 14, 2017
(86) PCT No.: PCT/US2017/051626

§ 371 Date: Jan. 30, 2020

(51) Int. Cl. E21B 21/06; E21B 43/267; B01F 5/04

(52) U.S. Cl. CPC E21B 21/062; B01F 2215/0081; B01F 5/0496; E21B 43/267

(57) ABSTRACT

A containment apparatus is provided having a container body enclosing an inner cavity for containing fluids. The container body has a mouth and a metering aperture each passing through the container body permitting fluidic communication from the inner cavity to outside the container body. A flexible inert barrier is provided within the inner cavity and fluidically separating the mouth and the metering aperture, the flexible inert barrier forming a protective liner along the surface of the inner cavity when filled with a harsh fluid introduced from the mouth, and collapsible toward the mouth upon a greater differential pressure experienced from a benign fluid introduced from the metering aperture whereby the harsh fluid is forced out of the mouth, a portion of the surface of the inner cavity being exposed to the benign fluid upon collapse of the flexible inert barrier.

### FIELD

The present disclosure relates to fluid containment and delivery systems for wellbore oil and gas operations. In particular, the present disclosure relates to an apparatus, method, and system for containing, delivering and blending fluids for delivery downhole.

### BACKGROUND

Many oil and gas processes involve pumping various treatment fluids down a wellbore. The fluids are generally made up of a number of components and additives each serving particular functions depending on the nature of the process, problems encountered, and desired outcome. Accordingly, it is necessary to deliver, store and properly prepare such fluids, and to do so effectively and efficiently. Many of the fluids are harsh, having corrosive and abrasive properties, making their handling difficult and negatively impacting the life of equipment.

One of the major oil and gas processes is stimulation, which involves inducing the production of hydrocarbons from a subterranean formation. This may include hydraulic fracturing and/or acidization processes. In a typical hydraulic fracturing treatment, a treatment fluid often referred to as a “fracturing fluid” is pumped through a wellbore and into a subterranean formation producing zone at a rate and pressure such that one or more fractures are formed or extended into the zone. Various fluids and materials are pumped downhole in support of this process including aqueous or oil base fluids, gelling agents, cross-linkers, breakers, buffering agents, proppants, diversion materials, as well as other components. Accordingly, proper equipment is required to handle, mix and deliver such materials downhole.

### BRIEF DESCRIPTION OF THE DRAWINGS

In order to describe the manner in which the advantages and features of the disclosure can be obtained, reference is made to embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is an illustration depicting a containment apparatus according to an exemplary embodiment of the present disclosure;

FIG. 1B is an illustration depicting a containment apparatus according to an exemplary embodiment of the present disclosure

FIG. 2 is an illustration depicting a blending and mixing system according to an exemplary embodiment of the present disclosure;

FIG. 3 is an illustration depicting a blending and mixing system according to an exemplary embodiment of the present disclosure;

FIG. 4 is an illustration depicting a blending and mixing system according to an exemplary embodiment of the present disclosure;

FIG. 5 is an illustration depicting a static blending system according to an exemplary embodiment of the present disclosure; and

FIG. 6 is an illustration depicting a static blending system, according to an exemplary embodiment of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

It should be understood at the outset that although illustrative implementations of one or more embodiments are illustrated below, the disclosed compositions and methods may be implemented using any number of techniques. The disclosure should in no way be limited to the illustrative implementations, drawings, and techniques illustrated herein, but may be modified within the scope of the appended claims along with their full scope of equivalents.

In the following discussion and in the claims, the terms “including” and “comprising” are used in an open-ended fashion, and thus should be interpreted to mean “including, but not limited to . . . ”.

### Overview

Many fluids, including harsh chemicals, which are required for various oil and gas processes are usually transported and delivered to an oil site in various containers by truck. The containers are usually drained by using a suction tube that feeds a metering pump that accurately meters the chemical into the blending system. The metering pump, therefore, must be designed to withstand the chemical being pumped, and furthermore, must be thoroughly cleaned after use. Despite this, even with proper cleaning and maintenance, the metering pumps may be damaged due to contaminants that could be present in the metered fluid. Accordingly, disclosed herein is a containment apparatus and system for handling harsh fluids and which only exposes the pumping system to benign fluids.

Disclosed herein is a container having a generally tubular body enclosing an internal cavity for containing fluids. The container has an inert flexible barrier, for example a bladder, which lines the internal cavity such that when a harsh fluid is added, the barrier protects the surface and prevents contact by the harsh fluid. In order to pump out the harsh fluid contained in the container within the flexible barrier, a benign fluid is pumped through a metering aperture of the container on the other side flexible barrier. Accordingly, as the benign fluid is pumped in, the flexible barrier collapses and the harsh fluid is correspondingly forced out of the mouth of the container. The benign fluid then fills the space formerly taken by the harsh fluid, but behind the flexible barrier, and contacts the surface of the internal cavity. The harsh fluid is as a result precisely metered out of the mouth of the container due to its displacement by the benign fluid.

Accordingly, the metering pump and internal surface of the container is exposed only to the benign fluid thereby preserving the pump equipment. Furthermore, the harsh fluids, which maybe corrosive and/or abrasive, are kept behind the inert flexible barrier. The harsh fluids do not interact with the metering pumps. Furthermore, the containers can be delivered already filled and/or re-used with the same harsh fluids so as avoid contamination.

A plurality of containers can be combined together, so as to meter out the harsh fluids to a common line. In this way, the harsh fluids can be mixed together or with a base fluid as they are metered out. Further, they can be pumped to an active mixer and then downhole. Alternatively they can be pumped downhole without any intervening active mixer, with only a static mixer. This way, the harsh fluids can be delivered, stored, and metered out accurately and efficiently without contamination from any external environments.

### Description

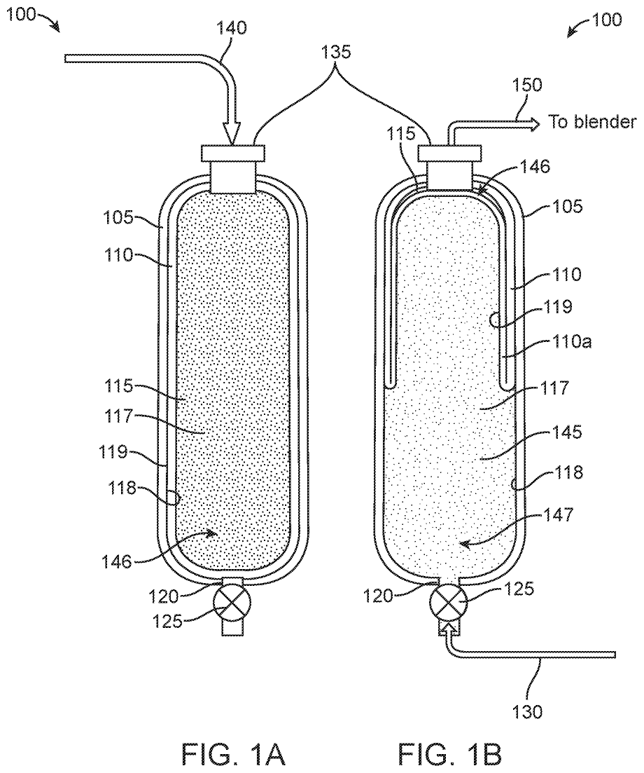

Illustrated in FIGS. 1A and 1B is a containment apparatus 100 according to an exemplary embodiment of the present disclosure. As shown in FIG. 1A the containment apparatus 100 has a container body 105. The container body 105 may have in internal cavity 117 for containing fluids. The container body 105 may be tubular in shape, and may be made of a strong material such as metal, including steel, a metal alloy, or a composite, such as a fiber glass wound vessel, so as to contain fluids at high pressure. For instance the container body may have a pressure limit of 10 to 1000 psi, alternatively from 100 to 500 psi, alternatively from 300 to 400 psi, encompassing any value and subset therebetween. An inert flexible barrier 110 is provided within the internal cavity 117 and may also be referred to as a bladder, and may be expandable or non-expandable. The inert flexible barrier separates the internal cavity 117 of the container body 105 into two portions, a harsh fluid portion 146 and a benign fluid portion 147. A mouth 135 is provided at the top of the container body 105 and passes through the container body 105 to the harsh fluid portion 146 of internal cavity 117 permitting fluidic communication for receiving and discharging a harsh fluid 115. The mouth 135 may have a valve in order to fluidically couple a line 140 from a truck or other external tank so as to receive a harsh fluid under pressure and/or without exposure to the atmosphere. The container body 105 may also have a metering aperture 120 passing through the container body 105 to a benign fluid portion 147 of the cavity 117 permitting fluidic communication for receiving a benign fluid 145.

The benign fluid portion 147 of the cavity 117 is formed by the border of the container surface 118 of the body 105 and the outer surface 119 of the inert flexible barrier 110 facing the metering aperture 120. Likewise, the harsh fluid portion 146 of the cavity 117 is formed by the border of the inert flexible barrier 110 facing the mouth 135. The harsh fluid portion 146 will expand when harsh fluid 115 is provided through mouth 135, and contract as benign fluid 145 is metered through the metering aperture 120. Likewise, the benign fluid portion 147 expands as benign fluid 145 is metered through the metering aperture 120 and contracts when harsh fluid 115 is injected through the mouth 135 and/or benign fluid 145 is extracted from metering aperture 120.

Accordingly, the inert flexible barrier 110 serves as a barrier between the mouth 135 and the metering aperture 120 so as to separate the harsh fluids 115 input through mouth 135 from the benign fluids 145 input from metering aperture 120. The inert flexible barrier 110 is made such that it is inert and non-reactive to any chemicals which may be in the harsh fluids 115, while also being inert and non-reactive to the benign fluids 145. As illustrated in FIG. 1A, the inert flexible barrier 110 may serve as a liner covering the surface 118 of the external cavity 147. When harsh fluid 115 is injected through the mouth 135 into the container body 105, the inert flexible barrier 110 will fill up (the harsh fluid portion 146 expanding). The incoming harsh fluid assists in evenly spreading and pressing the inert flexible barrier 110 across its outer surface 119 to the surface 118 of the internal cavity 117 (thereby contracting the benign fluid portion 147 to essentially zero volume). Accordingly, the inert flexible barrier 110 may extend from around the mouth 135 (but not covering the mouth), across the entire surface 118 of the internal cavity 117. Alternatively or additionally, the mouth 135 may be part of the barrier 110, and fastened into the body 105. This prevents any contact or exposure of the surface 118 of the internal cavity 117 to the harsh fluid from mouth 135. The harsh fluid 115 would then always be contained within the harsh fluid portion 146 internal cavity 117. This can serve to protect and lengthen the life of the containment body 105 while also preventing contact with a metering pumping system.

The harsh fluid 115 may be input into the container body 105 off-site and delivered via truck to an oilfield site. Alternatively, the container body 105 may be filled while on-site from a delivering truck and used immediately or stored indefinitely for use. The harsh fluid 115 may be pumped out in a controlled way, or metered out, of the mouth 135 by pumping in, or metering in, benign fluid 145 into the external cavity 147 as shown in FIG. 1B through the metering aperture 125. A line 130 may couple with the valve 125 to meter in benign fluid 145 from a metering pump (not shown). The pumping in of a benign fluid 145 places pressure against the flexible inert barrier 110 causing it to collapse toward the mouth 135, shown by collapsed portion 110a of the flexible inert barrier 110. The pressure differential between the harsh fluid 115 on one side of the inert flexible barrier 110 and the benign fluid 145 on the other, caused by the introduction of the benign fluid 145 from the metering aperture 125, forces the harsh fluid 115 out of the mouth 135. In particular, the metering of the benign fluid in the metering aperture 125 causes the corresponding metering out of the harsh fluid 115 from the mouth 135. Given that the amount input from the metering aperture 125 equals the amount output from the mouth 135, the metering of the harsh fluid 115 can be controlled with the metering pump.

The containment apparatus 100 permits the harsh fluid 115 to be kept separate from equipment that may be contaminated or damaged over time by contact with the harsh fluid. It also permits the pumping equipment to only make contact with a benign fluid 145 which is kept separate from the harsh fluid 115, and can be used to meter the harsh fluid 115. The harsh fluid may be any corrosive chemical, abrasive fluid, benign but hard to clean chemicals, oils, oil gels (such as Halliburton's My-T-Oil V™ system) or a “dirty fluid.” For instance, the harsh fluid may be include gelling agents (such as liquid gel concentrate), cross-linkers, surfactants such as HySurf and Lo-Surf™ series of surfactants sold by Halliburton Energy Services, Inc., scavengers, breakers, acids, buffering agents, caustic chemicals, or other harsh chemicals. Abrasive fluids may include liquid proppant (such as a proppant suspended in a gelling agent at a high density), gravel, or other particulates, which with flow of the fluid causes abrasion and wearing out of equipment. Hard to clean materials could plate out or clog metering equipment as such that they become inaccurate over time.

Suitable gelling agents may include various hydratable, swellable or soluble polymer, which include for instance polysaccharides, guar gum, cellulose, synthetic polymers such as polyacrylate, polymethacrylate, polyacrylamide, polyvinyl alcohol, and polyvinylpyrrolidone, and derivatives of the aforementioned. Crosslinkers typically comprise at least one ion that is capable of crosslinking at least two gelling agent molecules. Examples of suitable crosslinkers include, but are not limited to, boric acid, borates, disodium octaborate tetrahydrate, sodium diborate, pentaborates, ulexite and colemanite, compounds that can supply zirconium IV ions. Suitable proppants include proppants, microproppants, ultra light weight proppants, gravel, or any fine or coarse solid particles, including for example, sand, bauxite, ceramic, gravel, glass, polymer materials, polytetrafluoroethylene materials, nut shell pieces, cured resinous particulates having nut shell pieces, seed shell pieces, cured resinous particulates having seed shell pieces, fruit pit pieces, cured resinous particulates having fruit pit pieces, wood, composite particulates, and any combination thereof. Acids may include HCl, HF, acetic acids or other. Breakers include oxiders such as peroxides, hydroperoxides, hydrogen peroxide, as well as persulfates, including sodium persulfate and ammonium persulfate, as well as other breakers. The benign fluid includes any “clean” fluid which does not contaminate or wear the pump. This may include water, freshwater, distilled water, mineral oil, other light oils, anti-freeze, and the like.

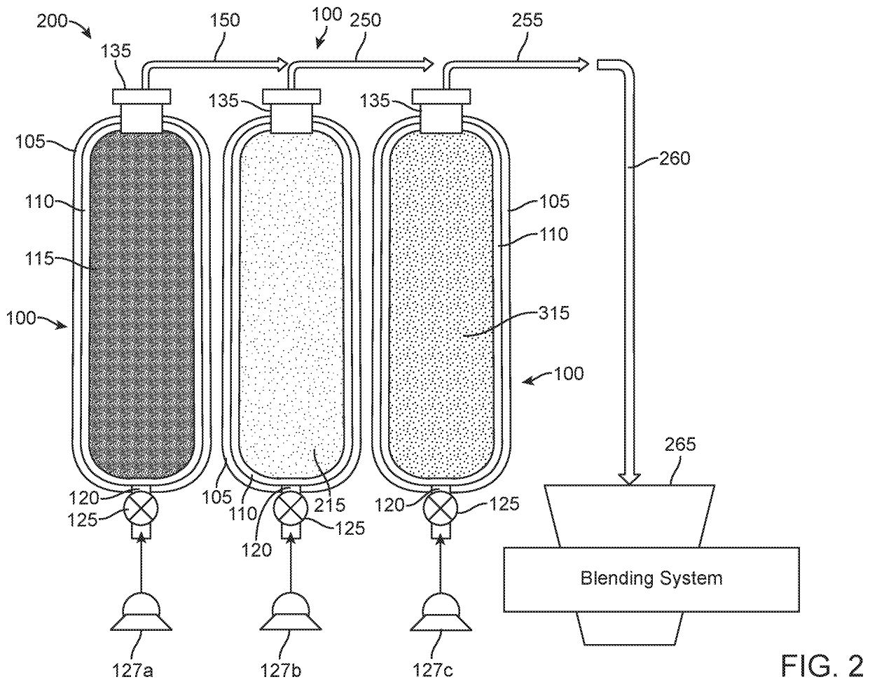

Illustrated in FIG. 2 is a blending and mixing system 200, having three containment apparatuses 100, with the components being the same as that in FIGS. 1A and 1B for each containment apparatus 100, except each having a different harsh fluid 115, 215 and 315. Each of the harsh fluids 115, 215, 315 may be metered/pumped from their respective exit lines 150, 250, and 255 into common line 260 where they will naturally mix in the common line 260 and/or mixed in blending system 265. The blending system may be an active blender, where power (gas or electric) is supplied to drive an impeller for mixing and blending the contents. Alternatively, each containment apparatus 100 may have the same harsh fluid, such as liquid proppant. For instance, each containment apparatus 100 may have 25,000 to 35,000 pounds of liquid proppant, which are metered out into blending system 265. The mouths 135 may have a sealed coupling with the exit lines 150, 250, and 255 so that the harsh fluids will not be exposed to the atmosphere as they are metered out. This permits the use of harsh fluids which may be reactive with the atmosphere avoid exposure is avoided. This may also allow storage of harsh fluid for a limited amount of time.

Further, as shown in system 200, each containment apparatus 100 may have an individual separate metering pump 127a, 127b, 127c coupled to the valves 125. In this way each containment apparatus 100 may be independently metered to pump out the harsh fluids 115, 215, 315 from the mouths 135 into common line 260 in a controlled manner providing more control. In each case, only a benign fluid would be pumped via the metering pumps 127a, 127b, 127c, which would protect such metering pumps, the surface of the inner cavity of the containment apparatuses 100 and other equipment from wear. Alternatively, a single metering pump may be coupled with each of the valves 125, however, in such case less independent control may be available for metering out the harsh fluids from containment apparatuses 100. This is especially applicable for situations where the containment systems contain the same or similar fluids.

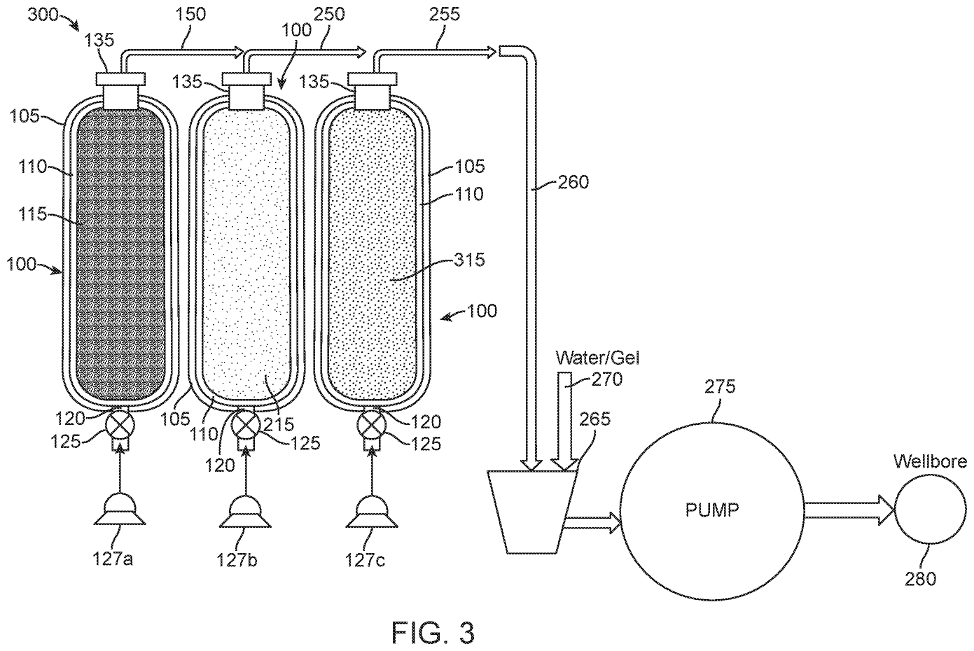

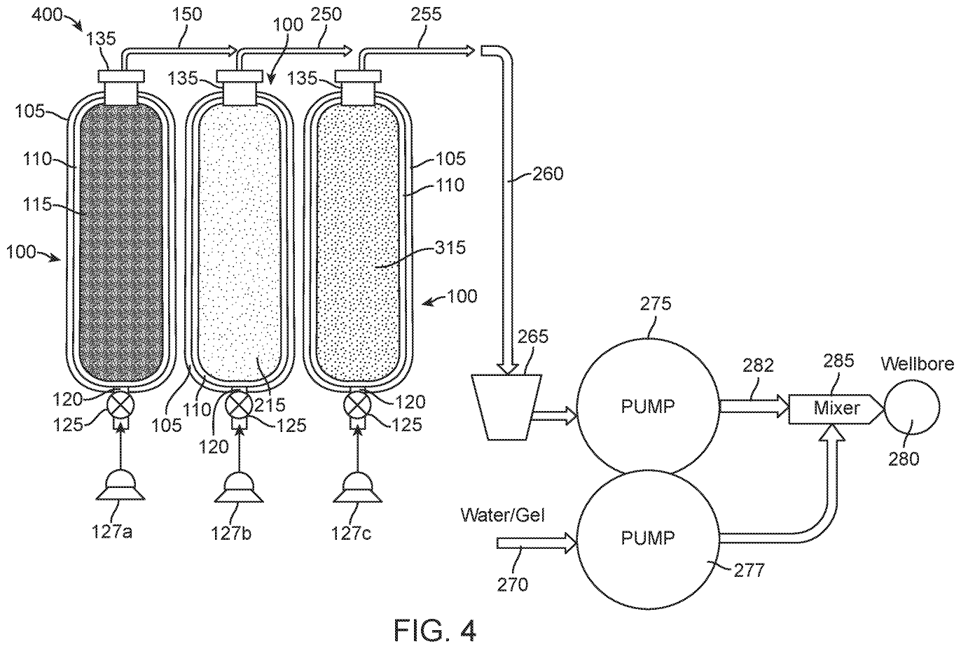

Illustrated in FIG. 3 is a blending and mixing system 300, being the same containment apparatuses 100 as in FIG. 2, however, a separate line 270 of a mixture or solution of gelling agents and water may be provided to the blending system 265 thereby mixing with the harsh fluids 115, 215, 315 from the containment apparatuses 100. These are then provided to pump 275 and the mixture is then pumped down the wellbore 280. FIG. 4 illustrates a blending and mixing system 400, the components and reference numerals being the same as in FIGS. 2 and 3. However, in system 400, as compared to system 300 in FIG. 3, the water and gel mixture is provided via the separate line 270 into a separate pump 277. The harsh chemicals from containment apparatuses 100 are provided from common line 260 through the blending system 265. The water and gel mixture is provided via separate pump 277 along with the harsh chemicals pumped by pump 275 through line 282, into mixer 285. The mixer 285 may be an active mixer which has provided with a power source having an element such as a rotatable mixing the components therein. The mixer 285 may also be a static mixer. The harsh fluids along with the water gel are mixed together via mixer 285 and injected downhole via the motive power of pumps 275 and 277. When the mixer 285 is a static mixer, the harsh fluids passing from the containment apparatuses 100 to a wellbore 280 without an intervening active blender. In both FIGS. 3 and 4, due to the pump 275 and blending system 265 being exposed to the harsh chemicals they are more subject to wear.

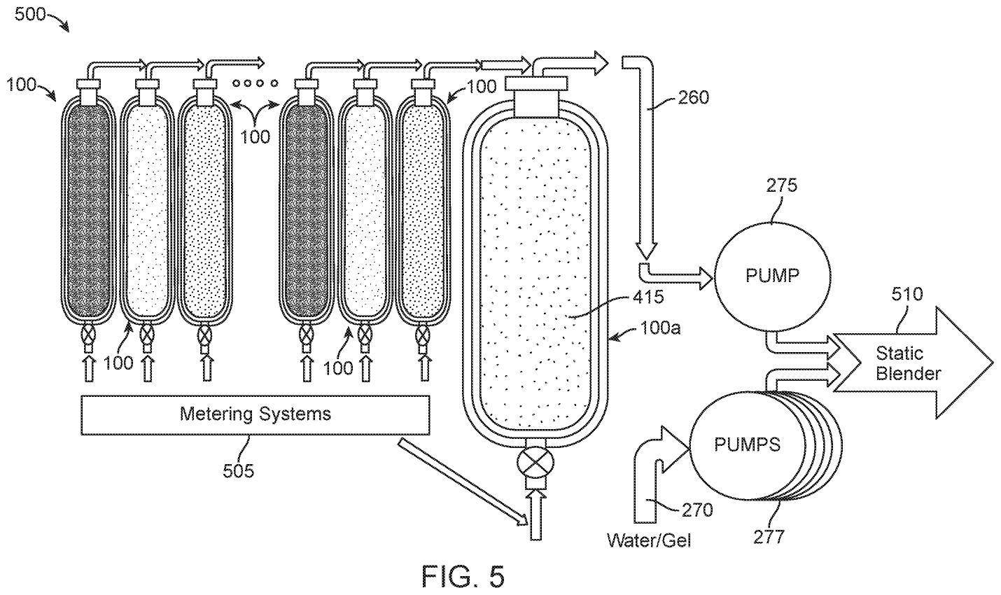

Illustrated in FIG. 5 is a static blending system 500, and which may be referred to as a blenderless system in the sense that no active blender is present. In particular, the metering provided according to the containment apparatuses 100 are sufficient in themselves to effectively mix without the addition of an active blender. This improves efficiency and costs associated with providing an active blender, and also reduces the carbon footprint. A plurality of containment devices as in FIGS. 1-5 can meter one or more harsh fluids into a common line, and then into a static blender and then passed into a wellbore.

As can be seen in FIG. 5, the system 500 has a plurality of containment apparatuses 100. Each of the containment apparatuses 100 are the same as have the containment apparatus 100 in FIGS. 1-4. While six containment apparatuses 100 are shown, there can be any number as shown by the ellipses between the groups of three in FIG. 5. In system 500 each of the plurality of containment apparatuses 100 contain the same or different harsh fluid. The final containment apparatus 100a (having the same components as containment apparatuses 100) in FIG. 5 contains liquid sand 415, and so may be larger than the other of the plurality of containment apparatuses 100, as each may be different sizes depending on the harsh fluid contained. The metering system 505 may be a single metering pump into each of the containment apparatuses 100 or each of the plurality of containment apparatuses 100 having its own metering pump.

As shown each of the plurality of containment apparatuses 100 are metered into common line 260 and then pump 275. Simultaneously, a mixture or solution of water and gel 270 is provided to pumps 277. The harsh fluids from pump 275 and the water and gel 270 from pumps 275 and 277, respectively, are pumped into static blender 510. The mixed material would then be further passed downhole in a wellbore. Accordingly, FIG. 5 shows the harsh fluids passing from the containment apparatuses to a wellbore 280 without an intervening active blender. A static blender 510 is a blender without an electrical power source, and may have no moving parts such as an impeller or blade. The static blender 510 may include shaped internal tube or barriers which cause perturbation of the fluid passing through. The static blender 510 may include a fluidic oscillator to cause sweeping or pulsing of fluids as they exit the static blender 510. The static blender 510 may include two or more types of static mixing designs in order to maximize a blending effect.

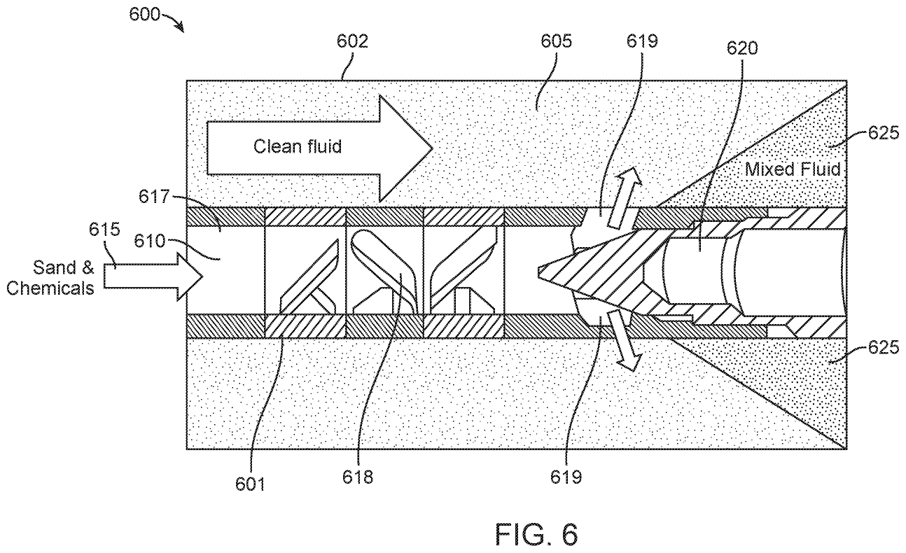

An exemplary static blender 600 is illustrated in FIG. 6. Static blender 600 may have an inner tube 601 extending within an outer tube 602. The inner tube 601 may have an entrance 610 into which the harsh fluid 615 (which may include liquid proppant) is injected which may be from pump 275 in FIG. 5. The static blender 600 may have an inner bore 617 with spirals or indents 618, or projections for perturbing the harsh fluid for mixing at low rates. The static blender 600 has a fluidic spinner/oscillator 620 for causing the fluid to sweep or pulsate as it is jettisoned out of ports 619. In the annulus between the inner tube 601 and the outer tube 602 an additional fluid 605 can flow, and which may be a benign fluid such as water and gel from pump 277 in FIG. 5, or it may be any other kind of fluids such as acids, or may be fluids from other systems such as system 500, or may be high pressure foams (mixture os gas and liquids), crude oil, produced gas and the like.

As the harsh fluid 615 is ejected from ports 619 and the additional fluid 605 it forms a mixed fluid 625. The mixed fluid can then be provided down a wellbore. The end of the static blender 600 can pass the mixed fluid 625 into another pump or directly into the wellbore. Further, the end of the static blender 600 may be placed in distance in the wellbore such that it is already within the wellbore when ejected.

While the static blender 600 is illustrated as exemplary other static blending systems maybe suitably employed.

The containment apparatus and systems described in FIGS. 1-6 may be employed in any number of oil and gas operations requiring the containment, blending, and delivery of fluids. These including for instance various stimulation processes including fracturing, acidization, as well as production processes.

### Statements of the Disclosure Include:

Statement 1: A containment apparatus including: a container body enclosing an inner cavity for containing fluids; a mouth and a metering aperture each passing through the container body permitting fluidic communication from the inner cavity to outside the container body; a flexible inert barrier provided within the inner cavity and fluidically separating the mouth and the metering aperture, the flexible inert barrier preventing contact with a surface of the inner cavity by a first fluid when the first fluid is introduced from the mouth, and collapsible toward the mouth upon a greater differential pressure experienced from a second fluid introduced from the metering aperture whereby the first fluid is forced out of the mouth, a portion of the surface of the inner cavity being exposed to the second fluid upon collapse of the flexible inert barrier.

Statement 2: The containment apparatus of Statement 1 further including a metering pump coupled with the metering aperture for pumping the second fluid therein.

Statement 3: The containment apparatus according to one of Statement 1 or Statement 2 further including a line extending from the mouth to an entrance of a wellbore without an intervening active blender.

Statement 4: The containment apparatus according to any one of the preceding Statements 1-3 wherein the first fluid is a harsh fluid and the second fluid is a benign fluid.

Statement 5: The containment apparatus according to any one of the preceding Statements 1-4 wherein the flexible inert barrier forms a protective liner along a surface of the inner cavity when filled with the first fluid introduced from the mouth.

Statement 6: The containment apparatus according to any one of the preceding Statements 1-5 further including a line extending from the mouth and coupled with a plurality of container bodies.

Statement 7: A fluid containment and delivery system comprising: a container body enclosing an inner cavity for containing fluids; a mouth and a metering aperture each passing through the container body permitting fluidic communication from the inner cavity to outside the container body; a flexible inert barrier provided within the inner cavity and fluidically separating the mouth and the metering aperture, the flexible inert barrier preventing contact with a surface of the inner cavity by a first fluid when the first fluid is introduced from the mouth, and collapsible toward the mouth upon a greater differential pressure experienced from a second fluid introduced from the metering aperture whereby the first fluid is forced out of the mouth, a portion of the surface of the inner cavity being exposed to the second fluid upon collapse of the flexible inert barrier.

Statement 8: The fluid containment and delivery system of Statement 7 further comprising a metering pump coupled with the metering aperture for pumping the second fluid therein.

Statement 9: The fluid containment and delivery system according to Statement 7 or Statement 8 further including a line extending from the mouth to an entrance of a wellbore without an intervening active blender.

Statement 10: The fluid containment and delivery system according any one of the preceding Statements 7-9 comprising a line extending from the mouth to an entrance of a wellbore having a pump and an active blender.

Statement 11: The fluid containment and delivery system according any one of the preceding Statements 7-10 further including a plurality of the container bodies fluidically coupled via a line, each containing a different fluid.

Statement 12: The fluid containment and delivery system according any one of the preceding Statements 7-11, wherein each of the plurality of the container bodies having an individual metering pump coupled to the metering aperture of each of the plurality of container bodies.

Statement 13: The fluid containment and delivery system according any one of the preceding Statements 7-12, wherein a metering pump is coupled to each of the metering apertures of each of the plurality of the container bodies via a shared line.

Statement 14: The fluid containment and delivery system according any one of the preceding Statements 7-13 wherein the first fluid is a harsh fluid and the second fluid is a benign fluid.

Statement 15: A method comprising: pumping a benign fluid from a metering pump into a metering aperture of a container body, the container body having an inner cavity for containing fluids, a mouth and the metering aperture each passing through the container body permitting fluidic communication from the inner cavity to outside the container body; a flexible inert barrier provided within the inner cavity and fluidically separating the mouth and the metering aperture, the flexible inert barrier preventing contact with a surface of the inner cavity by a harsh fluid when the harsh fluid is introduced from the mouth; and collapsing the flexible inert barrier toward the mouth as a result of pressure experienced from the benign fluid being pumped through the metering aperture whereby the harsh fluid is pumped out of the mouth, a portion of the surface of the inner cavity being exposed to the benign fluid upon collapse of the flexible inert barrier.

Statement 16: The method according to Statement 15 wherein the harsh fluid is at least one of a corrosive or an abrasive fluid.

Statement 17: The method according to Statement 15 or Statement 16 pumping the harsh fluid from the mouth into a wellbore without an intervening active blender.

Statement 18: The method according any one of the preceding Statements 15-17 further including pumping the harsh fluid from the mouth via a first line, and pumping a separate fluid comprising a mixture of water and a gelling agent from a separate line, to a static mixer.

Statement 19: The method according any one of the preceding Statements 15-18 pumping the harsh fluid out of the mouth into a line extending to an entrance of a wellbore, the line having a pump and an active blender.

Statement 20: The method according any one of the preceding Statements 15-19 further including a plurality of the container bodies each having a different harsh fluid, the method further comprising mixing the harsh fluids from each of the plurality of container bodies in a common line by pumping a benign fluid into the metering apertures of the plurality of container bodies whereby the different harsh fluids are pumped from the mouth of each of the container bodies into the common line.

1. A containment apparatus comprising:
a container body enclosing an inner cavity for containing fluids;
a mouth and a metering aperture each passing through the container body permitting fluidic communication from the inner cavity to outside the container body;
a flexible inert barrier provided within the inner cavity and fluidically separating the mouth and the metering aperture, the flexible inert barrier preventing contact with a surface of the inner cavity by a first fluid when the first fluid is introduced from the mouth, and collapsible toward the mouth upon a greater differential pressure experienced from a second fluid introduced from the metering aperture whereby the first fluid is forced out of the mouth, a portion of the surface of the inner cavity being exposed to the second fluid upon collapse of the flexible inert barrier.

2. The containment apparatus of claim 1 further comprising a metering pump coupled with the metering aperture for pumping the second fluid therein.

3. The containment apparatus of claim 2 further comprising a line extending from the mouth to an entrance of a wellbore without an intervening active blender.

4. The containment apparatus of claim 1 wherein the first fluid is a harsh fluid and the second fluid is a benign fluid.

5. The containment apparatus of claim 1 wherein the flexible inert barrier forms a protective liner along a surface of the inner cavity when filled with the first fluid introduced from the mouth.

6. The containment apparatus of claim 1 further comprising a line extending from the mouth and coupled with a plurality of container bodies.

7. A fluid containment and delivery system comprising:
a container body enclosing an inner cavity for containing fluids;
a mouth and a metering aperture each passing through the container body permitting fluidic communication from the inner cavity to outside the container body;
a flexible inert barrier provided within the inner cavity and fluidically separating the mouth and the metering aperture, the flexible inert barrier preventing contact with a surface of the inner cavity by a first fluid when the first fluid is introduced from the mouth, and collapsible toward the mouth upon a greater differential pressure experienced from a second fluid introduced from the metering aperture whereby the first fluid is forced out of the mouth, a portion of the surface of the inner cavity being exposed to the second fluid upon collapse of the flexible inert barrier.

8. The fluid containment and delivery system of claim 7 further comprising a metering pump coupled with the metering aperture for pumping the second fluid therein.

9. The fluid containment and delivery system of claim 8 further comprising a line extending from the mouth to an entrance of a wellbore without an intervening active blender.

10. The fluid containment and delivery system of claim 8 further comprising a line extending from the mouth to an entrance of a wellbore having a pump and an active blender.

11. The fluid containment and delivery system of claim 7 further comprising a plurality of the container bodies fluidically coupled via a line, each containing a different fluid.

12. The fluid containment and delivery system of claim 11, wherein each of the plurality of the container bodies having an individual metering pump coupled to the metering aperture of each of the plurality of container bodies.

13. The fluid containment and delivery system of claim 11, wherein a metering pump is coupled to each of the metering apertures of each of the plurality of the container bodies via a shared line.

14. The fluid containment and delivery system of claim 7 wherein the first fluid is a harsh fluid and the second fluid is a benign fluid.

15. A method comprising:
pumping a benign fluid from a metering pump into a metering aperture of a container body, the container body having
an inner cavity for containing fluids,
a mouth and the metering aperture each passing through the container body permitting fluidic communication from the inner cavity to outside the container body;
a flexible inert barrier provided within the inner cavity and fluidically separating the mouth and the metering aperture, the flexible inert barrier preventing contact with a surface of the inner cavity by a harsh fluid when the harsh fluid is introduced from the mouth; and
collapsing the flexible inert barrier toward the mouth as a result of pressure experienced from the benign fluid being pumped through the metering aperture whereby the harsh fluid is pumped out of the mouth, a portion of the surface of the inner cavity being exposed to the benign fluid upon collapse of the flexible inert barrier.

16. The method of claim 15 wherein the harsh fluid is at least one of a corrosive or an abrasive fluid.

17. The method of claim 15 pumping the harsh fluid from the mouth into a wellbore without an intervening active blender.

18. The method of claim 17 further comprising pumping the harsh fluid from the mouth via a first line, and pumping a separate fluid comprising a mixture of water and a gelling agent from a separate line, to a static mixer.

19. The method of claim 15 pumping the harsh fluid out of the mouth into a line extending to an entrance of a wellbore, the line having a pump and an active blender.

20. The method of claim 15 comprising a plurality of the container bodies each having a different harsh fluid, the method further comprising
mixing the harsh fluids from each of the plurality of container bodies in a common line by pumping a benign fluid into the metering apertures of the plurality of container bodies whereby the different harsh fluids are pumped from the mouth of each of the container bodies into the common line.
